(19) United States
(12) Patent Application Publication
(10) Pub. No.: US 2026/0270997 A1
(43) Pub. Date: Sep. 10, 2026

(54) METHOD AND APPARATUS FOR DETERMINING A TRANSPORT BLOCK SIZE IN SUB-BAND FULL DUPLEX

(71) Applicant: LENOVO (BEIJING) LIMITED, Beijing (CN)

(72) Inventors: Ruixiang Ma, Beijing (CN); Yuantao Zhang, Beijing (CN); Hongmei Liu, Beijing (CN); Zhi Yan, Beijing (CN); Haiming Wang, Beijing (CN)

(21) Appl. No.: 18/869,500

(22) PCT Filed: May 27, 2022
(86) PCT No.: PCT/CN2022/095726

§ 371 Date: Nov. 26, 2024

(51) Int. Cl. H04W 72/21; H04W 72/0453

(52) U.S. Cl. CPC H04W 72/21; H04W 72/0453

(57) ABSTRACT

Embodiments of the present application are directed to a method and apparatus for determining a transport block size in a sub-band full duplex. In an embodiment of the present application, a user equipment comprise: a wireless transceiver; and a processor coupled to the wireless transceiver. The processor is configured to: determine at least two frequency resources for physical uplink shard channel (PUSCH) transmission for transmitting a transport block; determine a transport block size for the PUSCH transmission based on one or more of the at least two frequency resources; and perform, via the wireless transceiver, the transport block with the at least two frequency resources on the uplink data channel PUSCH transmission. The at least two frequency resources have at least two different sizes.

### TECHNICAL FIELD

Embodiments of the present application generally relate to wireless communication technology, and especially to a method and apparatus for determining a transport block size in sub-band full duplex.

### BACKGROUND

In the new radio (NR), an available transport block size (TBS) may be determined for a transmission on a physical uplink shared channel (PUSCH). In this way, the user equipment (UE) can transmit the data based on the determined TBS, and the base station (BS) can receive the data based on the same TBS.

### SUMMARY OF THE APPLICATION

Embodiments of the present application provide methods and apparatuses for determining a transport block size in sub-band full duplex.

An embodiment of the present application provides a user equipment (UE) comprising: a wireless transceiver; and a processor coupled to the wireless transceiver. The processor is configured to: determine at least two frequency resources for physical uplink shard channel (PUSCH) transmission for transmitting a transport block; determine a transport block size of the PUSCH transmission based on one or more of the at least two frequency resources; and perform, via the wireless transceiver, the PUSCH transmission. The at least two frequency resources have at least two different sizes.

Another embodiment of the present application provides a base station (BS) comprising a wireless transceiver; and a processor coupled to the wireless transceiver. The processor is configured to: determine at least two frequency resources for physical uplink shard channel (PUSCH) transmission for transmitting a transport block; determine a transport block size of the PUSCH transmission based on one or more of the at least two frequency resources; and receive, via the wireless transceiver, the PUSCH transmission. The at least two frequency resource have at least two different sizes.

A further embodiment of the present application provides a method performed by a first user equipment (UE). The method comprises: determining at least two frequency resources for physical uplink shard channel (PUSCH) transmission for transmitting a transport block; determining a transport block size of the PUSCH transmission based on one or more of the at least two frequency resources; and performing the PUSCH transmission. The at least two frequency resources have at least two different sizes.

A further embodiment of the present application provides a method performed by a first base station (BS). The method comprises: determining at least two frequency resources for physical uplink shard channel (PUSCH) transmission for transmitting a transport block; determining a transport block size of the PUSCH transmission based on one or more of the at least two frequency resources; and receiving the PUSCH transmission. The at least two frequency resource have at least two different sizes.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a wireless communication system according to some embodiments of the present application;

FIG. 2 is a diagram of PUSCH transmissions based on PUSCH repetition Type A according to some embodiments of the present application;

FIG. 3 is a diagram of PUSCH transmissions based on PUSCH repetition Type B according to some embodiments of the present application;

FIG. 4 is a diagram of PUSCH transmissions based on enhanced PUSCH repetition Type A according to some embodiments of the present application;

FIG. 5 is a diagram of PUSCH transmissions based on transport block processing over multi-slot according to some embodiments of the present application;

FIG. 6 is a diagram of a sub-band full duplex scheme according to some embodiments of the present application;

FIG. 7 is a diagram of an indicated frequency domain resource crossing multiple sub-bands configured with different transmission direction, according to some embodiments of the present application;

FIG. 8 is a diagram of resource allocation for PUSCH with PUSCH repetition type A or enhanced PUSCH repetition type A, according to some embodiments of the present application;

FIG. 9 is a diagram of resource allocation for PUSCH with PUSCH repetition type B, according to some embodiments of the present application;

FIG. 10 is a diagram of resource allocation for PUSCH with PUSCH repetition type B, according to some embodiments of the present application;

FIG. 11 is a diagram of resource allocation for PUSCH with TBOMS, according to some embodiments of the present application;

FIG. 12 is a flow chart of a method for determining a transport block size (TBS) according to some embodiments of the present application;

FIG. 13 is a flow chart of another method for determining a TBS according to an embodiment of the present application; and

FIG. 14 is a block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings.

FIG. 1 illustrates a wireless communication system 100 according to some embodiments of the present application. FIG. 1 includes a base station (BS) 101 and a user equipment (UE) 103. An uplink 105 and a downlink 107 are used to transmitted data and signal between the BS 101 and the US 103. In the uplink 105, a physical uplink control channel (PUCCH) and a physical uplink shared channel (PUSCH) may be implemented to transmit data and signal from the UE 103 to the BS 101. In the downlink 107, a physical downlink control channel (PDCCH) and a physical downlink shared channel (PDSCH) may be implemented to transmit data and signal from the BS to the UE.

### I. NR TB Size Determination for PDSCH

TB size determination for PDSCH is conducted as follows.
1) The UE first determine the number of REs (N_{RE}) within the slot,
   The UE first determines the number of REs allocated for PDSCH within a PRB (physical resource block) (N_{RE}′) by

$${N}_{RE}^{′} = {N}_{sc}^{RB} \cdot {N}_{symb}^{s h} - {N}_{DMRS}^{PRB} - {N}_{o h}^{PRB} ,$$

where

$${N}_{sc}^{RB} = 12$$

is the number of subcarriers in a physical resource block,

$${N}_{symb}^{sh}$$

is the number of symbols of the PDSCH allocation within the slot,

$${N}_{DMRS}^{PRB}$$

is the number of REs for DM-RS per PRB in the scheduled duration including the overhead of the DM-RS CDM groups without data, as indicated by DCI (Downlink Control Information) format 1_1 or format 1_2 or as described for format 1_0 in Clause 5.1.6.2, and

$${N}_{o h}^{PRB}$$

is the overhead configured by higher layer parameter xOverhead in PDSCH-ServingCellConfig. If the xOverhead in PDSCH-ServingCellconfig is not configured (a value from 6, 12, or 18), the

$${N}_{o h}^{PRB}$$

is set to 0. If the PDSCH is scheduled by PDCCH with a CRC scrambled by SI-RNTI, RA-RNTI, MSGB-RNTI or P-RNTI,

$${N}_{oh}^{PRB}$$

is assumed to be 0. If the PDSCH is scheduled by PDCCH with a CRC scrambled by G-RNTI or G-CS-RNTI or PDSCH without PDCCH is activated by PDCCH with a CRC scrambled by G-CS-RNTI,

$${N}_{oh}^{PRB}$$

is the overhead configured by higher layer parameter xOverhead-Multicast in PDSCH-Config-Multicast. If the xOverhead-Multicast in PDSCH-Config-Multicast is not configured, the

$${N}_{oh}^{PRB}$$

is set to 0.
The UE determines the total number of REs allocated for PDSCH (N_{RE}) by N_{RE}=min(156, N_{RE}′)·n_{PRB}, where n_{PRB} is the total number of allocated PRBs for the UE.
2) Unquantized intermediate variable (N_{info}) is obtained by N_{info}=N_{RE}·R·Qₘ·ν.
   If N_{info}≤3824
      Use step 3 as the next step of the TBS (transport block size) determination
   else
      Use step 4 as the next step of the TBS determination
   end if
3) When N_{info}≤3824, TBS is determined as follows
   quantized intermediate number of information bits

$${N}_{info}^{′} = max ( 24 , {2}^{n} \cdot ⌊ \frac{{N}_{info}}{{2}^{n}} ⌋ ) ,$$

where n=nMax(3,└ log₂(N_{info})┘−6).
use Table 1 find the closest TBS that is not less than

$${N}_{info}^{′} .$$

4) When N_{info}>3824, TBS is determined as follows.
   quantized intermediate number of information bits

$${N}_{info}^{′} = max ( 3840 , {2}^{n} \times round ( \frac{{N}_{info} - 24}{{2}^{n}} ) ) ,$$

$$where$$

$$n = ⌊ {log}_{2} ( {N}_{info} - 24 ) ⌋ - 5$$

and ties in the round function are broken towards the next largest integer.
if R≤¼

$$TBS = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{3816} ⌉$$

else
   if N_{info}′>8424

$$TBS = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{8424} ⌉$$

else

$$TBS = 8 \cdot ⌈ \frac{{N}_{info}^{′} + 24}{8} ⌉ - 24$$

end if
end if
else if Table 2 is used and 28≤I_{MCS}≤31,
   the TBS is assumed to be as determined from the DCI transported in the latest PDCCH for the same transport block using 0≤I_{MCS}≤27. If there is no PDCCH for the same transport block using 0≤I_{MCS}≤27, and if the initial PDSCH for the same transport block is semi-persistently scheduled, the TBS shall be determined from the most recent semi-persistent scheduling assignment PDCCH.
else if Table 3 is used and 27≤I_{MCS}≤31,
   the TBS is assumed to be as determined from the DCI transported in the latest PDCCH for the same transport block using 0≤I_{MCS}≤26. If there is no PDCCH for the same transport block using 0≤I_{MCS}≤26, and if the initial PDSCH for the same transport block is semi-persistently scheduled, the TBS shall be determined from the most recent semi-persistent scheduling assignment PDCCH.
else
   the TBS is assumed to be as determined from the DCI transported in the latest PDCCH for the same transport block using 0≤I_{MCS}≤28. If there is no PDCCH for the same transport block using 0≤I_{MCS}≤28, and if the initial PDSCH for the same transport block is semi-persistently scheduled, the TBS shall be determined from the most recent semi-persistent scheduling assignment PDCCH.

TABLE 1
TBS for N_{info} ≤3824

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

TABLE 2
a MCS index table for PDSCH

| MCS | Modulation | Target | |
|---|---|---|---|
| Index | Order | code Rate R x | Spectral |
| I_{MCS} | Qₘ | [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

TABLE 3
a MCS index table for PDSCH

| MCS | Modulation | Target | |
|---|---|---|---|
| Index | Order | code Rate R x | Spectral |
| I_{MCS} | Qₘ | [1024] | efficiency |
| 0 | 2 | 120 | 0.2344 |
| 1 | 2 | 193 | 0.3770 |
| 2 | 2 | 449 | 0.8770 |
| 3 | 4 | 378 | 1.4766 |
| 4 | 4 | 490 | 1.9141 |
| 5 | 4 | 616 | 2.4063 |
| 6 | 6 | 466 | 2.7305 |
| 7 | 6 | 517 | 3.0293 |
| 8 | 6 | 567 | 3.3223 |
| 9 | 6 | 616 | 3.6094 |
| 10 | 6 | 666 | 3.9023 |
| 11 | 6 | 719 | 4.2129 |
| 12 | 6 | 772 | 4.5234 |
| 13 | 6 | 822 | 4.8164 |
| 14 | 6 | 873 | 5.1152 |
| 15 | 8 | 682.5 | 5.3320 |
| 16 | 8 | 711 | 5.5547 |
| 17 | 8 | 754 | 5.8906 |
| 18 | 8 | 797 | 6.2266 |
| 19 | 8 | 841 | 6.5703 |
| 20 | 8 | 885 | 6.9141 |
| 21 | 8 | 916.5 | 7.1602 |
| 22 | 8 | 948 | 7.4063 |
| 23 | 10 | 805.5 | 7.8662 |
| 24 | 10 | 853 | 8.3301 |
| 25 | 10 | 900.5 | 8.7939 |
| 26 | 10 | 948 | 9.2578 |

| | | |
|---|---|---|
| 27 | 2 | reserved |
| 28 | 4 | reserved |
| 29 | 6 | reserved |
| 30 | 8 | reserved |
| 31 | 10 | reserved |

### II. NR TB Size Determination for PUSCH

For a PUSCH scheduled by RAR UL grant or
for a PUSCH scheduled by fallbackRAR UL grant or
for a PUSCH scheduled by a DCI format 0_0 with CRC scrambled by C-RNTI, MCS-C-RNTI, TC-RNTI, CS-RNTI, or
for a PUSCH scheduled by a DCI format 0_1 or DCI format 0_2 with CRC scrambled by C-RNTI, MCS-C-RNTI, CS-RNTI, or
for a PUSCH transmission with configured grant, or
for a MsgA PUSCH transmission,
if
   0≤I_{MCS}≤27 and transform precoding is disabled and Table 5.1.3.1-2 is used, or
   0≤I_{MCS}≤28 and transform precoding is disabled and a table other than Table 5.1.3.1-2 is used, or
   0≤I_{MCS}≤27 and transform precoding is enabled, the UE shall first determine the TBS as specified below:
   The UE shall first determine the number of REs (N_{RE}) within the slot:
      A UE first determines the number of REs allocated for PUSCH within a PRB (N_{RE}′) by

$${N}_{RE}^{′} = {N}_{sc}^{RB} \cdot {N}_{symb}^{sh} - {N}_{DMRS}^{PRB} - {N}_{oh}^{PRB} ,$$

where

$${N}_{sc}^{RB} = 12$$

is the number of subcarriers in the frequency domain in a physical resource block,

$${N}_{symb}^{sh}$$

is the number of symbols L of the PUSCH allocation according to Clause 6.1.2.1 for scheduled PUSCH or Clause 6.1.2.3 for configured PUSCH,

$${N}_{DMRS}^{PRB}$$

is the number of REs for DM-RS per PRB in the allocated duration including the overhead of the DM-RS CDM groups without data, as described for PUSCH with a configured grant in Clause 6.1.2.3 or as indicated by DCI format 0_1 or DCI format 0_2 or as described for DCI format 0_0 in Clause 6.2.2, and

$${N}_{o h}^{P R B}$$

is the overhead configured by higher layer parameter xOverhead in PUSCH-ServingCellConfig. If the

$${N}_{o h}^{P R B}$$

is not configured (a value from 6, 12, or 18), the

$${N}_{o h}^{P R B}$$

is assumed to be 0. For Msg3 or MsgA PUSCH transmission the

$${N}_{o h}^{P R B}$$

is always set to 0. In case of PUSCH repetition Type B,

$${N}_{D M R S}^{P R B}$$

is determined assuming a nominal repetition with the duration of L symbols without segmentation.
A UE determines the total number of REs allocated for PUSCH (N_{RE}) as follows
   For TB processing over multiple slots, N_{RE}=N*min(156,N_{RE}′)·n_{PRB} where n_{PRB} is the total number of allocated PRBs for the UE and Nis the number of slots used for TBS determination indicated by numberOfSlotsTBoMS.
   Otherwise, N_{RE}=min(156,N_{RE}′)·n_{PRB}.
Next, proceed with steps 2-4 as defined in TBS determination for PDSCH
For a PUSCH scheduled by fallbackRAR UL grant, UE assumes the TB size determined by the UL grant in the fallbackRAR shall be the same as the TB size used in the corresponding MsgA PUSCH transmission.
else if
   28≤I_{MCS}≤31 and transform precoding is disabled and Table 5.1.3.1-2 is used, or
   28≤I_{MCS}≤31 and transform precoding is enabled,
   the TBS is assumed to be as determined from the DCI transported in the latest PDCCH for the same transport block using 0≤I_{MCS}≤27. If there is no PDCCH for the same transport block using 0≤I_{MCS}≤27, and if the initial PUSCH for the same transport block is transmitted with configured grant,
      the TBS shall be determined from configuredGrantConfig for a configured grant Type 1 PUSCH.
      the TBS shall be determined from the most recent PDCCH scheduling a configured grant Type 2 PUSCH.
   else
   the TBS is assumed to be as determined from the DCI transported in the latest PDCCH for the same transport block using 0≤I_{MCS}≤28. If there is no PDCCH for the same transport block using 0≤I_{MCS}≤28, and if the initial PUSCH for the same transport block is transmitted with configured grant,
      the TBS shall be determined from configuredGrantConfig for a configured grant Type 1 PUSCH.
      the TBS shall be determined from the most recent PDCCH scheduling a configured grant Type 2 PUSCH.

### III. NR Resource Allocation

Before NR UE transmits PUSCH, including dynamic scheduled PUSCH and CG (configured grant) PUSCH, it receives frequency domain resource allocation assignment and time domain resource assignment from NR gNB (generalized NodeB) to determine the frequency and time domain resource of the PUSCH.

### III.1. Resource Allocation in Frequency Domain

For dynamically scheduled PUSCH and CG Type 2 PUSCH, the UE shall determine the resource assignment using the resource allocation field in the detected PDCCH DCI. But for CG Type 1 PUSCH, the resource assignment applied for the transmission are provided by higher layer parameter frequencyDomainAllocation in configuredGrantConfig. The frequency domain resource assignment indicates to a scheduled UE a set of resource blocks (RB) within the active bandwidth part. The RB indexing for resource allocation is determined within the UE's active bandwidth part.

### III.2. Resource Allocation in Time Domain

### III.2.i. Dynamically Scheduled PUSCH

For dynamically scheduled PUSCH, the ‘Time domain resource assignment’ field value m of the DCI provides a row index m+1 to an allocated table, and the used resource allocation table could be predefined by 3GPP specification or could be configured by higher layer parameter. The indexed row defines the slot offset K₂, the start and length indicator SLIV, or directly the start symbol S and the allocation length L, and the number of repetitions (if numberOfRepetitions is present in the resource allocation table) to be applied in the PUSCH transmission. Where, slot offset K₂ is used to indicate the number of slots between the DCI received slot and PUSCH transmitted slot.

There are four main schemes for resource allocation in time domain of dynamically scheduled PUSCH, including PUSCH repetition Type A introduced in Rel-15, and PUSCH repetition Type B introduced in Rel-16. Enhancements on PUSCH repetition type A are beneficial for PUSCH coverage enhancements for TDD. It is recommended to support in Rel-17. TB processing over multi-slot PUSCH (TBOMS) is beneficial for PUSCH coverage enhancements. It is recommended to support TBOMS in Rel-17. For a certain PUSCH transmission, the scheme used could be configured by higher layer parameter. Time domain resource allocation for these four schemes could be found as follows.

For PUSCH repetition Type A, the starting symbol S relative to the start of the slot, and the number of consecutive symbols L counting from the symbol S allocated for the PUSCH are determined from the start and length indicator SLIV of the indexed row.
if (L−1)≤7 then
   SLIV=14·(L−1)+S
else
   SLIV=14·(14−L+1)+(14−1−S)
where 0<L≤14−S.

When transmitting PUSCH scheduled by DCI format 0_1 or 0_2 in PDCCH with CRC scrambled with C-RNTI, MCS-C-RNTI, or CS-RNTI with NDI=1, the number of repetitions K is determined as
if numberOfRepetitions is present in the resource allocation table, the number of repetitions K is equal to numberOfRepetitions;
else if the UE is configured with pusch-AggregationFactor, the number of repetitions K is equal to pusch-AggregationFactor;
otherwise K=1.

For PUSCH repetition Type A, in case K>1, the same symbol allocation is applied across the K consecutive slots. The UE shall repeat the TB across the K consecutive slots applying the same symbol allocation in each slot.

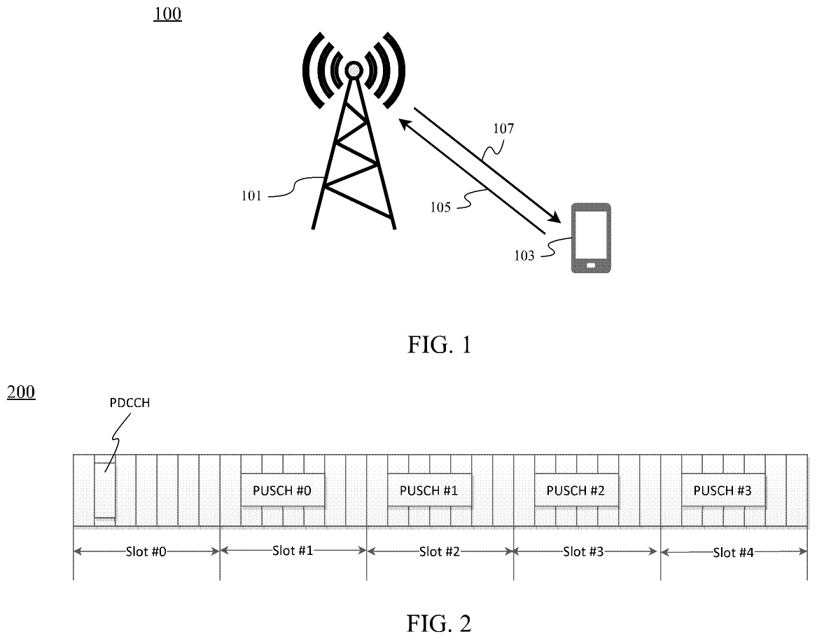

For example, assuming K₂=1, S=2 (indicating that the PUSCH transmission starts at the symbol #2, i.e., the third symbol), L=8 (indicating that the length of the PUSCH transmission is 8), K=4, then the time domain resource for PUSCH with PUSCH repetition Type A could be seen in FIG. 2. In FIG. 2, each slot includes 14 symbols, and one rectangle in one slot indicates 2 symbols. In FIG. 2, data transmitted in PUSCH #0 to PUSCH #3 are identical. Thus, the data transmitted in PUSCH #0 is transmitted 4 times in total.

For enhanced PUSCH repetition Type A, a PUSCH transmission in a slot of a multi-slot PUSCH transmission is omitted if any symbol of the PUSCH overlaps with the set of symbols of the slot that are indicated to a UE as downlink by tdd-UL-DL-ConfigurationCommon, or tdd-UL-DL-ConfigurationDedicated.

For PUSCH repetition Type B, the number of nominal repetitions is given by numberOfRepetitions. For the n-th nominal repetition, n=0, . . . , numberOfRepetitions−1,
The slot where the nominal repetition starts is given by

$${K}_{s} + ⌊ \frac{S + n \cdot L}{{N}_{symb}^{slot}} ⌋ ,$$

and the starting symbol relative to the start of the slot is given by

$$mod ( S + n \cdot L , {N}_{symb}^{s l o t} ) .$$

The slot where the nominal repetition ends is given by

$${K}_{s} + ⌊ \frac{S + ( n + 1 ) \cdot L - 1}{{N}_{symb}^{slot}} ⌋ ,$$

and the ending symbol relative to the start of the slot is given by

$$mod ( S + ( n + 1 ) \cdot L - 1 , {N}_{symb}^{s l o t} ) .$$

Here Kₛ is the slot where the PUSCH transmission starts, and

$${N}_{symb}^{slot}$$

is the number of symbols per slot. The starting symbol S relative to the start of the slot, and the number of consecutive symbols L counting from the symbol S allocated for the PUSCH are provided by startSymbol and length of the indexed row of the resource allocation table, respectively.

For PUSCH repetition Type B, a symbol that is indicated as downlink by tdd-UL-DL-ConfigurationCommon, or tdd-UL-DL-ConfigurationDedicated, is considered as an invalid symbol for PUSCH repetition Type B transmission. After determining the invalid symbol(s) for PUSCH repetition type B transmission for each of the K nominal repetitions, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of all potentially valid symbols that can be used for PUSCH repetition Type B transmission within a slot. An actual repetition with a single symbol is omitted except for the case of L=1.

An actual repetition is omitted if any symbol of the PUSCH is overlapped with the set of symbols of the slot that are indicated to a UE as downlink by tdd-UL-DL-ConfigurationCommon, or tdd-UL-DL-ConfigurationDedicated.

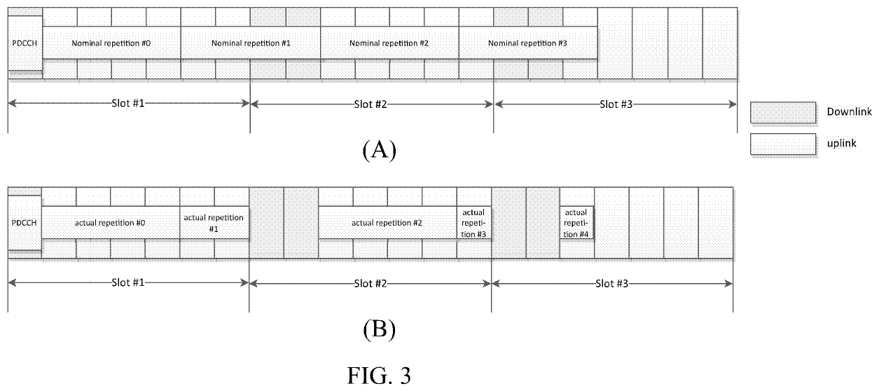

For example, assuming K₂=0, S=2, L=8, K=4, then the time domain resource for PUSCH with PUSCH repetition Type B could be seen in FIG. 3. In FIG. 3, each slot includes 14 symbols, and one rectangle in one slot indicates 2 symbols. FIG. 3 (A) shows four nominal repetitions (nominal repetition #0 to nominal repetition #3). Upon consideration of downlink transmissions indicated by tdd-UL-DL-ConfigurationCommon or tdd-UL-DL-ConfigurationDedicated, FIG. 3(B) shows five actual repetitions (actual repetition #0 to actual repetition #4), in which each of the five actual repetitions may occupy different symbols in a slot. As shown in FIG. 3(B), the symbols indicated as downlink are considered as invalid symbols for PUSCH repetition Type B transmission, and thus the actual repetitions in FIG. 3(B) are not continuous.

For enhanced PUSCH repetition Type A, the resource allocation in time domain is almost same as PUSCH repetition type A, excluding that the number of repetitions is counted on the basis of available slots. A slot is determined as unavailable if at least one of the symbols indicated by TDRA (Time domain resource allocation) for a PUSCH in the slot overlaps with the symbol not intended for UL transmissions, and semi-static flexible symbol configured by tdd-UL-DL-ConfigurationCommon, or tdd-UL-DL-ConfigurationDedicated, is considered as available.

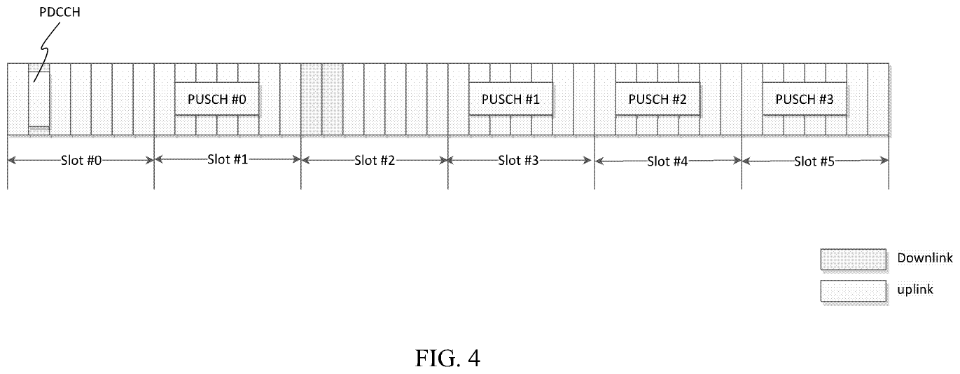

For example, assuming K₂=1, S=2, L=8, K=4, then the time domain resource for PUSCH with enhanced PUSCH repetition Type A could be seen in FIG. 4. In FIG. 4, each slot includes 14 symbols, and one rectangle in one slot indicates 2 symbols. In FIG. 4, data transmitted in PUSCH #0 to PUSCH #3 are identical. Thus, the data transmitted in PUSCH #0 is transmitted 4 times in total. In slot #2, the first symbol to fourth symbol are occupied by a downlink transmission (e.g., configured by tdd-UL-DL-ConfigurationCommon, or tdd-UL-DL-ConfigurationDedicated), and the transmissions of PUSCH #1 to PUSCH #3 are in slot #3-slot #5.

For TBOMS, time domain resource determination can be performed via PUSCH repetition Type A like TDRA. The number of slots K allocated for TBOMS is determined by using a row index of a TDRA list, configured via RRC and is counted based on the available slots for UL transmission. The transmission in each slot could be named as one transmission part of the TB in this invention. The determination of available slots is as defined in enhanced PUSCH repetition Type A.

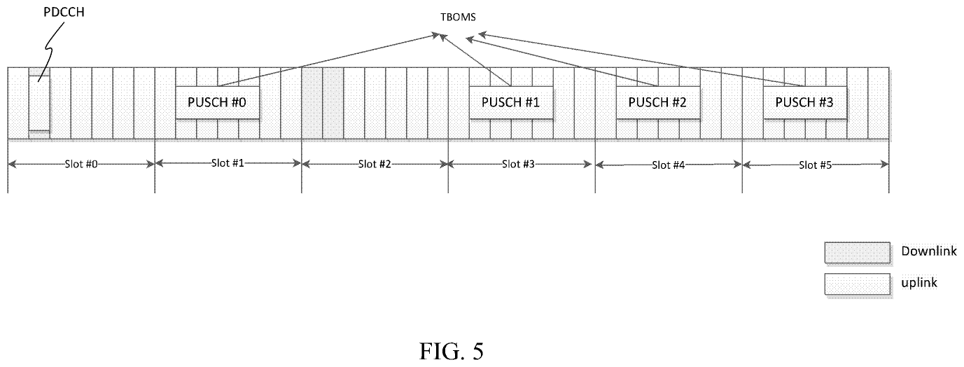

For example, assuming K₂=1, S=2, L=8, K=4, then the time domain resource for PUSCH with TBOMS could be seen in FIG. 5. In FIG. 5, each slot includes 14 symbols, and one rectangle in one slot indicates 2 symbols. In FIG. 5, data transmitted in PUSCH #0 to PUSCH #3 may be different. A transport block may be divided into four parts, and the four parts are transmitted in PUSCH #0 to PUSCH #3, respectively.

In slot #2, the first symbol to fourth symbol are occupied by a downlink transmission (e.g., configured by tdd-UL-DL-ConfigurationCommon, or tdd-UL-DL-ConfigurationDedicated), and the transmissions of PUSCH #1 to PUSCH #3 are in slot #3-slot #5.

### III.2.ii. CG PUSCH

For CG Type 1 PUSCH transmissions, the higher layer parameter timeDomainAllocation value m provides a row index m+1 pointing to the determined time domain resource allocation table, where the start symbol and length are determined following the procedure defined here for dynamically scheduled PUSCH. For CG Type 2 PU SCH transmissions, the resource allocation follows UL grant received on the DCI.

There are also four main schemes for resource allocation in time domain of CG PUSCH including Type 1 or Type 2. They have some difference with the schemes for dynamically scheduled PUSCH, such as PUSCH repetition Type A, PUSCH repetition Type B, enhanced PUSCH repetition Type A and TBOMS. The number of (nominal) repetitions K to be applied to the transmitted transport block is provided by the indexed row in the time domain resource allocation table if numberOfRepetitions is present in the table; otherwise K is provided by the higher layer configured parameters repK. Besides, other procedures defined in clause of dynamically scheduled could be reused.

For PUSCH repetition Type B, for PUSCH transmissions with a Type 1 or Type 2 configured grant, the nominal repetitions and the actual repetitions are determined according to the procedures for PUSCH repetition Type B defined in clause of dynamically scheduled PUSCH.

### IV. Sub-Band Full Duplex

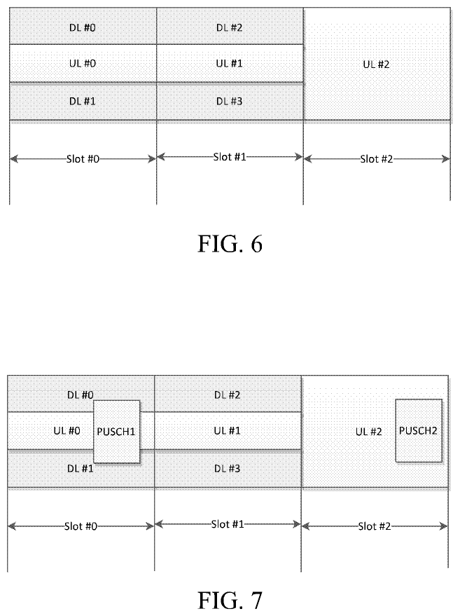

In order to realize the superior data rate and latency, 5G spectrum on higher frequency band is inevitable. Overcoming the coverage reduction on such carriers can be a challenge. 3GPP Rel.18 will probably introduce a new duplexing scheme that enables simultaneous use of downlink and uplink within a TDD carrier using non-overlapped frequency resource, which could be named as Sub-band full duplex. The intention of this scheme is to extend the duration over which uplink transmission could occur for improved the uplink coverage and capacity. And the simultaneous use of DL and UL is only at gNB and not at UE side. The example of duplexing scheme could be seen in FIG. 6. In FIG. 6, DL (downlink) #0 and DL #1 are duplex with UL (uplink) #0 in different sub-bands of slot #0. In FIG. 6, DL #2 and DL #3 are duplex with UL #1 in different sub-bands of slot #1.

According to the background NR resource allocation, it is observed that gNB could only indicate one frequency domain resource in the BWP (BandWidth Part). For PUSCH repetition Type A, PUSCH repetition Type B, and enhanced PUSCH repetition A, frequency resource of each repetition is same. For TBOMS, frequency resource of each part of the transmission is same.

As a result, in sub-band full duplex scenario, the indicated frequency domain resource may cross multiple sub-bands configured with different transmission direction in some slots, such as PUSCH 1 shown in FIG. 7. This situation could be avoided by indicating a small frequency domain resource by gNB, which means that the indicated frequency domain resource would cross multiple sub-bands configured with different transmission direction in any slot. For dynamically scheduled PUSCH without repetition, this method would not have any limitation. However, for CG PUSCH transmission without repetition or PUSCH with repetition or TBOMS, always indicating a small frequency domain resource is not reasonable considering the scheduling flexibility and resource utilization.

Therefore, some methods of the present application could be used to solve the issue of how to transmit PUSCH if the indicated frequency domain resource of PUSCH would cross multiple sub-bands configured with different transmission direction in sub-band full duplex scenario. The embodiments of the present application are described as follows.

### IV.1. Solution 1: At Least Two Frequency Domain Resources are Indicated, and they are for Different Slot Separately

### IV.1.i. Solution 1-1

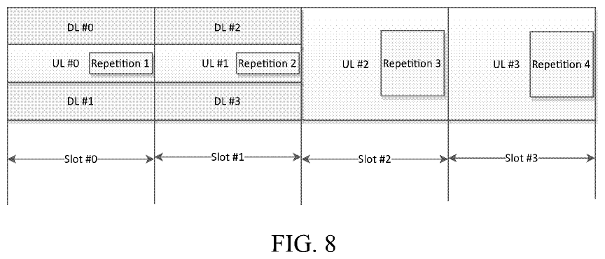

For PUSCH transmission with PUSCH repetition type A, these two resource assignments could be different and are used to indicate two frequency domain resource used in slots configured with sub-band full duplex scheme and normal slots respectively. For example, in FIG. 8, slot #0 and slot #1 are configured with sub-band full duplex scheme, one frequency domain resource was used for PUSCH repetition land PUSCH repetition 2; and the other frequency domain resource is used for PUSCH repetition 3 and PUSCH repetition 4 in normal slot #2 and slot #3.

### IV.1.ii. Solution 1-2

For PUSCH transmission with PUSCH repetition type B, these two resource assignments could be different and are used to indicate two frequency domain resource used in slots configured with sub-band full duplex scheme and normal slots respectively.

### IV.1.ii.1. Solution 1-2-1

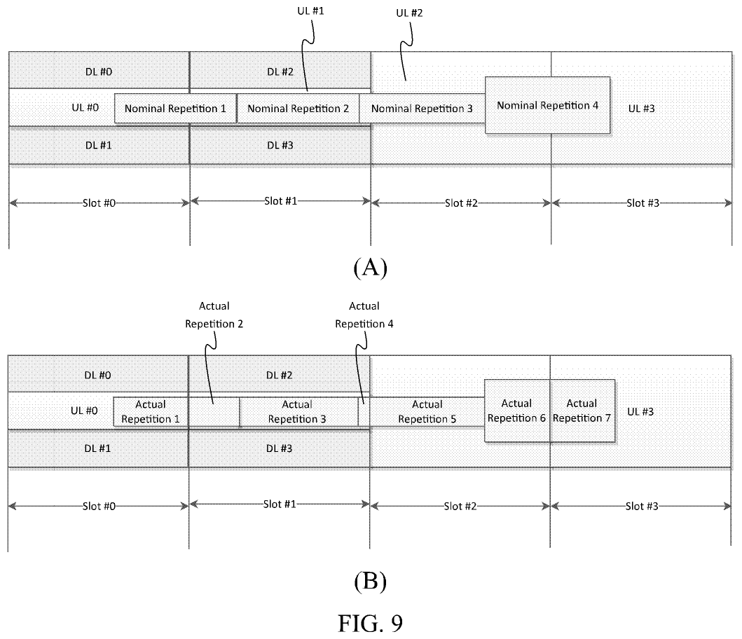

For each nominal PUSCH repetition, the used frequency domain resource is chosen according to the whether the occupied slot (decided by the starting symbol) of the nominal repetition is configured with sub-band full duplex scheme. For example, in FIG. 9 (A), the starting symbol of nominal repetition 1, nominal repetition 2 and nominal repetition 3 are in slot #0 and slot #1 who are configured with sub-band full duplex scheme, so one lower frequency domain resource configured for slots with sub-band full duplex was used for nominal repetition 1, nominal repetition 2 and nominal repetition 3, the other frequency domain resource is used for nominal repetition 4. After that, the resource for actual repetition could be determined according to current technology in section 1, for example in FIG. 9 (A), the determined actual repetition could be found in FIG. 9 (B), seven (7) actual repetitions are decided for PUSCH transmission.

### IV.1.ii.2. Solution 1-2-2

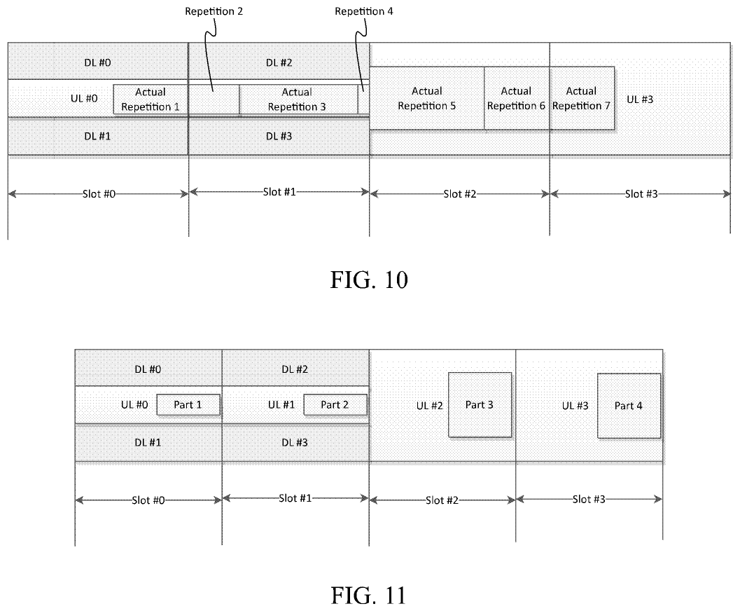

For each actual PUSCH repetition, the used frequency domain resource is chosen according to the whether the occupied slot of the actual repetition is configured with sub-band full duplex scheme. For example, in FIG. 10, in slot #0 and slot #1 configured with sub-band full duplex scheme, one frequency domain resource was used for actual PUSCH repetition 1 to actual PUSCH repetition 4, in normal slot #2 and slot #3, the other frequency domain resource is used for actual PUSCH repetition 5, actual PUSCH repetition 6, and actual PUSCH repetition 7.

### IV.1.ii. Solution 1-3

For PUSCH transmission with TBOMS, two resource assignments could be different and are used to indicate two frequency domain resources used in slots configured with sub-band full duplex scheme and normal slots respectively.

For each transmission part, the used frequency domain resource is chosen according to whether the occupied slot of transmission part is configured with sub-band full duplex scheme. For example, in FIG. 11, in slot #0 and slot #1 configured with sub-band full duplex scheme, one frequency domain resource was used for transmission part 1 and transmission part 2, in normal slot #2 and slot #3, the other frequency domain resource is used for transmission part 3 and transmission part 4.

### IV.2. Solution 2: One Frequency Domain Resource is Indicated, then UE Adjusts this Resource to Adapt the Sub-Band Configuration According to Predefined Rules

For example, for a slot without sub-band full duplex, the indicated frequency resource is applied; and for a slot with sub-band full duplex, the applied frequency resource would be reduced to fit the size of the sub-band. In this way, at least two frequency domain resources could be determined for different slot separately. Use of these two resources could be the same as Embodiment 1.

For all embodiments in the disclosure of the present application, the term “slot” could be replaced by “time unit.” A time unit may be one or multiple frames, one or multiple sub-frames, one or multiple slots, one or multiple sub-slots, or one or multiple symbols.

According to the solutions, we can find that in full duplex scenario, for PUSCH repetition Type A, TB processing over multiple slots, or PUSCH repetition Type B, there could be at least two frequency domain resources determined for PUSCH transmission and the size of these frequency domain resources could be different. However, the TBS can be determined based on only one size of these frequency domain resources. How to determine TBS using one or more of the at least two frequency domain resources should be determined.

The disclosure of the present application proposes embodiments to determine TBS when there are at least two frequency domain resources determined for PUSCH transmission in sub-band full duplex scenario. We assume UE knows the used frequency domain resources in each slot or each repetition.

When at least two frequency domain resources are determined for PUSCH transmission in full duplex scenario, determining TBS may include Step 1 and Step 2. Furthermore, Step 2 may be either Step 2-1 or Step 2-2.

### V. Step 1

determining at least two frequency domain resources for multiple PUSCH transmissions with PUSCH repetition type A or PUSCH repetition type B, or for PUSCH transmission in multiple slots with TBOMS.

The at least two frequency domain resources include at least two numbers of RBs.

The exemplary operation of step 1 could be, but is not limited to, any of Embodiments 1 or 2 disclosed here.

### VI. Step 2-1

determining the TBS for the PUSCH transmission based on one RB number of at least two numbers of RBs.

### VI.1. Embodiment 1

The one RB number is the number of RBs of the first frequency domain resource used by the first PUSCH transmission. That is, only the size of the frequency domain resource used by the first PUSCH transmission is used to determine the TBS. The noted frequency resource is used for a first repetition of the PUSCH transmission in time domain or is used for the PUSCH transmission in a first slot. In this embodiment, the TBS can be determined earlier and simple since the frequency domain resource used by the first PUSCH transmission is used to determine the TBS.

Some examples of Embodiment 1 follow.
For PUSCH repetition type A, first PUSCH transmission is the first repetition.
For PUSCH repetition type B, first PUSCH transmission is the first actual repetition or nominal repetition.
For TBOMS, the first PUSCH transmission is the PUSCH transmission in first slots.
The first PUSCH transmission could be further omitted by semi-static DL symbol configured by tdd-UL-DL-ConfigurationCommon or tdd-UL-DL-ConfigurationDedicated, or dynamic signaling.
The first PUSCH transmission is the first PUSCH transmission of all the remaining PUSCH transmission after omitting by semi-static DL symbol configured by tdd-UL-DL-ConfigurationCommon or tdd-UL-DL-ConfigurationDedicated.

In some embodiments, the operations of Embodiment 1 for Step 2-1 may be as follows.

| - | A UE determines the total number of REs allocated for PUSCH (N_{RE}) as | |
|---|---|---|
| | follows | |
| | - | For TB processing over multiple slots, N_{RE} = N * min(156, N′_{RE}) · n_{PRB} |
| | | where n_{PRB} is the total number of allocated PRBs of the first frequency |
| | | domain resource used by the PUSCH transmission in first slot for the UE |
| | | and N is the number of slots used for TBS determination indicated by |
| | | numberOfSlotsTBoMS. |
| | - | Otherwise, N_{RE} = min(156, N′_{RE}) · n_{PRB}. where n_{PRB} is the total number of |
| | | allocated PRBs of the first frequency domain resource used by the first |
| | | PUSCH transmission. |

### VI.1.i. Embodiment 1-1

For PUSCH with PUSCH repetition type A, the first PUSCH transmission is the first PUSCH repetition in time domain. The first PUSCH transmission could be further omitted by semi-static DL symbol configured by tdd-UL-DL-ConfigurationCommon or tdd-UL-DL-ConfigurationDedicated, or dynamic signaling.

As shown in FIG. 8, the first PUSCH transmission is repetition 1 in slot #0. So, the TBS determination is based on the number of RBs for repetition 1.

In some embodiments, the repetition 1 could be further omitted by semi-static DL symbol configured by tdd-UL-DL-ConfigurationCommon or tdd-UL-DL-ConfigurationDedicated, or dynamic signaling.

### VI.1.ii. Embodiment 1-2

For PUSCH with PUSCH repetition type A, the first PUSCH transmission is the first PUSCH repetition of all the remaining PUSCH repetitions after omitting by semi-static DL symbol configured by tdd-UL-DL-ConfigurationCommon or tdd-UL-DL-ConfigurationDedicated.

As shown in FIG. 8, assuming repetition 1 is omitted by semi-static DL symbol configured by tdd-UL-DL-ConfigurationCommon or tdd-UL-DL-ConfigurationDedicated, or dynamic signaling, the first PUSCH transmission is repetition 2 in slot #1. Thus, the TBS determination is based on the number of RBs for repetition 2.

### VI.1.iii. Embodiment 1-3

For PUSCH with PUSCH repetition type B, the first PUSCH transmission is the first nominal PUSCH repetition in time domain.

The first PUSCH transmission could be further omitted by semi-static DL symbol configured by tdd-UL-DL-ConfigurationCommon or tdd-UL-DL-ConfigurationDedicated, or dynamic signaling.

As shown in FIG. 9(A), the first PUSCH transmission is nominal repetition 1 in slot #0. So the TBS determination is based on the number of RBs for nominal repetition 1.

### VI.1.iv. Embodiment 1-4

For PUSCH with PUSCH repetition type B, the first PUSCH transmission is the first nominal PUSCH repetition of all the remaining PUSCH repetitions after omitting by semi-static DL symbol configured by tdd-UL-DL-ConfigurationCommon or tdd-UL-DL-ConfigurationDedicated.

As shown in FIG. 9(A), assuming nominal repetition 1 is omitted by semi-static DL symbol configured by tdd-UL-DL-ConfigurationCommon or tdd-UL-DL-ConfigurationDedicated, or dynamic signaling, the first PUSCH transmission is nominal repetition 2 in slot #1. Thus, the TBS determination is based on the number of RBs for nominal repetition 2.

### VI.1.v. Embodiment 1-5

For PUSCH with PUSCH repetition type B, the first PUSCH transmission is the first actual PUSCH repetition in time domain.

The first PUSCH transmission could be further omitted by semi-static DL symbol configured by tdd-UL-DL-ConfigurationCommon or tdd-UL-DL-ConfigurationDedicated, or dynamic signaling.

As shown in FIG. 9(B), the first PUSCH transmission is actual repetition 1 in slot #0. That is, the TBS determination is based on the number of RBs for actual repetition 1.

### VI.1.vi. Embodiment 1-6

For PUSCH with PUSCH repetition type B, the first PUSCH transmission is the first actual PUSCH repetition of all the remaining actual PUSCH repetitions after omitting by semi-static DL symbol configured by tdd-UL-DL-ConfigurationCommon or tdd-UL-DL-ConfigurationDedicated.

As shown in FIG. 9(B), assuming actual repetition 1 is omitted by semi-static DL symbol configured by tdd-UL-DL-ConfigurationCommon or tdd-UL-DL-ConfigurationDedicated, or dynamic signaling, the first PUSCH transmission is actual repetition 2 in slot #1. That is, the TBS determination is based on the number of RBs for actual repetition 2.

### VI.1.vii. Embodiment 1-7

For PUSCH transmission with TBOMS, the first PUSCH transmission is the PUSCH transmission in first slot. The first PUSCH transmission could be further omitted by dynamic signaling.

As shown in FIG. 11, the first PUSCH transmission is part 1 in slot #0. Thus, the TBS determination is based on the number of RBs for part 1.

### VI.2. Embodiment 2

the one RB number is the number of RBs of the frequency domain resource used by a certain PUSCH transmission, wherein the certain PUSCH transmission could be indicated by the RRC signaling or DCI signaling from gNB, or could be predefined in 3GPP specification. The transport block size may be determined based on a frequency resource size of one repetition of the PUSCH transmission. The one repetition may be indicated by the BS or predetermined in the protocol. The PUSCH transmission may use PUSCH repetition type B.

The transport block size may be determined based on a frequency resource size of the PUSCH transmission on one slot. The one slot may be indicated by the BS or predetermined in the protocol. The PUSCH transmission may use PUSCH repetition type A or TBOMS.

Embodiment 2 may be similar to Embodiment 1 of Step 2-1. With respect to Embodiment 1, Embodiment 2 uses the frequency resource size used by a certain PUSCH transmission rather than the frequency resource size used by the first PUSCH transmission. For example, the certain PUSCH transmission may be the second PUSCH transmission or the last PUSCH transmission.

### VI.3. Embodiment 3

the one RB number is the smallest number of RBs of the at least two numbers of RBs. The transport block size may be determined based on the smallest size of the at least two frequency resource. In this case, the determined TBS may be lower, resulting in lower code rate and better robustness of communication.

### VI.3.i. Embodiment 3-1

For PUSCH with PUSCH repetition type A, as shown in FIG. 8, there are two numbers of RBs. So the TBS determination is based on the smaller number of RBs, such as the number of RBs for repetition 1 or repetition 2.

### VI.4. Embodiment 4

the one RB number is the biggest (or highest) number of RBs of the at least two numbers of RBs. The transport block size may be determined based on the biggest (or highest) size of the at least two frequency resource. In this case, the determined TBS may be bigger (higher), which may result in higher code rate and higher capacity.

### VI.4.i. Embodiment 4-1

For PUSCH with PUSCH repetition type B, as shown in FIG. 9(B), there are two numbers of RBs. So the TBS determination is based on the bigger (higher) number of RBs, such as the number of RBs for actual repetition 6 or repetition 7.

### VI.5. Embodiment 5

the one RB number is the number of RBs used by PUSCH transmission in normal slot, wherein the normal slot is the slot not for sub-band full duplex. The transport block size may be determined based on the size of one frequency resource of the at least two frequency resources, and the one frequency resource is used for the PUSCH transmission in a time unit without sub-band full-duplex transmission.

### VI.5.i. Embodiment 5-1

For PUSCH with PUSCH repetition type A, as shown in FIG. 8, there are two numbers of RBs. So the TBS determination is based on the number of RBs for PUSCH transmission in normal slot, such as slot #2 and slot #3.

### VI.6. Embodiment 6

the one RB number is the number of RBs used by PUSCH transmission in sub-band full duplex slot. The transport block size may be determined based on a size of one frequency resource of the at least two frequency resources, and the one frequency resource is used for the PUSCH transmission in a time unit with sub-band full-duplex transmission.

### VI.6.i. Embodiment 6-1

For PUSCH with PUSCH repetition type B, as shown in FIG. 9 (B), there are two numbers of RBs. So the TBS determination is based on the number of RBs for actual repetition PUSCH transmission in dull duplex slot, such as slot #0 or slot #1.

### VI.7. Embodiment 7

the one RB number is indicated by gNB from the at least two numbers of PRBs. The transport block size may be determined based on one size indicated by the BS among the at least two different sizes.

A gNB could indicate using largest size or smallest size, using the size in a full-duplex slot or a normal slot, or using one of the at least two numbers of RBs indicated by RRC signaling or DCI to the TBS determination.

### VI.8. Embodiment 8

the one RB number is the number of RBs used by more PUSCH transmission. The transport block size may be determined based on the size of one frequency resource of the at least two frequency resources, and the one frequency resource is used most frequently for the PUSCH transmission.

In Embodiment 8, the one RB number may be used by more PUSCH transmission of all the remaining PUSCH transmission after omitting by semi-static DL symbol configured by tdd-UL-DL-ConfigurationCommon or tdd-UL-DL-ConfigurationDedicated.

### VI.8.i. Embodiment 8-1

As shown in FIG. 9 (B), five (5) actual repetitions use smaller (lower) RB number and only one (1) uses bigger (higher) RB number. Since the repetitions using smaller RB number is more than that using bigger RB number, the smaller RB number is used for the TBS determination.

For Embodiments 1-8 of the Step 2-1, UE does not expect the coding rate exceeds the maximum code rate.

### VI.9. Embodiment 9

the TBS determination is also based on one scaling factor and one RB number of at least two numbers of RBs. The one RB number of at least two numbers of RBs may be determined based on the operations disclosed in any of Embodiments 1-8 of Step 2-1. The transport block size may be determined based on a scaling factor and one or more of the at least two frequency resources, and the scaling factor is assigned by the BS or predetermined in the protocol.

A UE determines the total number of REs allocated for PUSCH (N_{RE}) as follows.
For TB processing over multiple slots,

$${N}_{R E} = N * min ( 1 \; 56 , {N}_{R E}^{′} ) \cdot {n}_{P R B} * f where {n}_{P R B}$$

is the total number of allocated PRBs for the UE and N is the number of slots used for TBS determination indicated by numberOfSlotsTBoMS. Where f is the scaling factor.
Otherwise,

$${N}_{R E} = min ( 1 \; 56 , {N}_{R E}^{′} ) \cdot {n}_{P R B} * f .$$

### VI. Step 2-2

Determining the TBS for the PUSCH transmission based on the at least two numbers of RBs

A UE determines the total number of REs allocated for PUSCH (N_{RE}) as follows.
For TB processing over multiple slots,

$${N}_{R E} = {\sum }_{i = 1}^{N} [ min ( 156 , {N}_{R E}^{′} ) \cdot {n}_{P R B} ( i ) ]$$

where n_{PRB}(i) is the total number of allocated PRBs for the UE in i th slot among N slots, and Nis the number of slots used for TBS determination indicated by numberOfSlotsTBoMS.
or For TB processing over multiple slots,

$${N}_{R E} = {\sum }_{i = 1}^{M} [ min ( 156 , {N}_{R E}^{′} ) \cdot {n}_{P R B} ( i ) \cdot N ( i ) ]$$

where n_{PRB}(i) is one of the total number of allocated PRBs for the UE among M numbers of RBs, and N(i) is the number of slots using n_{PRB}(i) among N slots for TBS determination, and N is indicated by numberOfSlotsTBoMS.

For PUSCH transmission with TBOMS, as shown in FIG. 11, the total number of allocated PRBs for the UE in first and second slot is R1, and the total number of allocated PRBs for the UE in third and fourth slot is R2. So,

$${N}_{R E} = min ( 1 \; 56 , {N}_{R E}^{′} ) * R 1 * 2 + min ( 1 \; 56 , {N}_{R E}^{′} ) * R 2 * 2 .$$

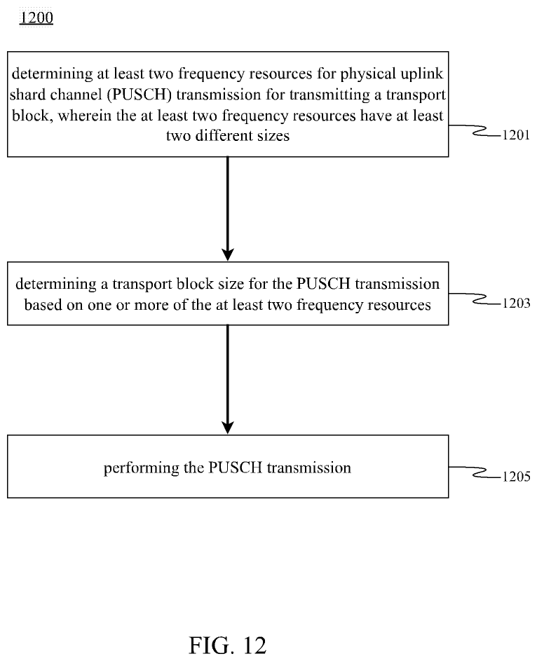

FIG. 12 is a flow chart of a method 1200 performed by a UE according to some embodiments of the present application. The method illustrated in FIG. 12 may be performed by the UE 103 in FIG. 1.

The method 1200 includes operations 1201, 1203, and 1205. In the operation 1201, the UE may determine at least two frequency resources for physical uplink shard channel (PUSCH) transmission for transmitting a transport block, wherein the at least two frequency resources have at least two different sizes. In the operation 1203, the UE may determine a transport block size for the PUSCH transmission based on one or more of the at least two frequency resources. In operation 1205, the UE performs the PUSCH transmission. The at least two different sizes may be a number of resource blocks (RBs) or a number of resource elements (REs).

In some embodiments, the PUSCH transmission may be used for repeated transmissions of the transport block on one or multiple slots or may be used for transmitting the transport block over the multiple slots. In the PUSCH repetition Type B scheme, the PUSCH transmission may be used for repeated transmissions of the transport block on one slot.

In some embodiments, the PUSCH transmission for transmitting the transport block may use one of the following schemes: physical uplink share channel (PUSCH) repetition type A, PUSCH repetition type B, or transport block processing over multi-slot (TBOMS).

In some embodiments, the transport block size of the PUSCH transmission may be determined based on one of the at least two frequency resources.

In some embodiments, the transport block size may be determined based on a size of one frequency resource of the at least two frequency resources. The one frequency resource may be used for a first repetition of the PUSCH transmission in time domain or may be used for the PUSCH transmission in a first slot.

In some embodiments, the first repetition may be a first actual repetition or a first nominal repetition in time domain.

In some embodiments, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments, the transport block size may be determined based on a first frequency resource size of one repetition of the PUSCH transmission indicated by a base station (BS) or predetermined in a protocol. The one repetition of the PUSCH transmission may be an actual repetition or a nominal repetition. The PUSCH transmission may use PUSCH repetition type B.

In some embodiments, the transport block size may be determined based on a second frequency resource size of the PUSCH transmission on one slot. The one slot may be indicated by abase station (BS) or predetermined in the protocol. The PUSCH transmission may use PUSCH repetition type A or TBOMS.

In some embodiments, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments, the transport block size may be determined based on a smallest size of the at least two frequency resources.

In some embodiments, the transport block size may be determined based on a biggest size of the at least two frequency resources.

In some embodiments, the transport block size may be determined based on a size of one frequency resource of the at least two frequency resources, and the one frequency resource is used for the PUSCH transmission in a time unit without sub-band full-duplex transmission. The time unit may be a slot, a symbol, a frame, a sub-frame, or a sub-slot.

In some embodiments, the transport block size may be determined based on a size of one frequency resource of the at least two frequency resources. The one frequency resource may be used for the PUSCH transmission in a time unit with sub-band full-duplex transmission. The time unit may be a slot, a symbol, a frame, a sub-frame, or a sub-slot.

In some embodiments, the transport block size may be determined based on one size indicated by a base station (BS) among the at least two different sizes.

In some embodiments, the transport block size may be determined based on a size of one frequency resource of the at least two frequency resources. The one frequency resource may be used most frequently for the PUSCH transmission.

In some embodiments, the transport block size may be determined based on a scaling factor and one or more of the at least two frequency resources. The scaling factor may be assigned by a BS or predetermined in a protocol.

In some embodiments, the at least two frequency resources may be used for transmitting the transport block over multiple slots. The transport block size may be determined based on all sizes of the at least two different sizes.

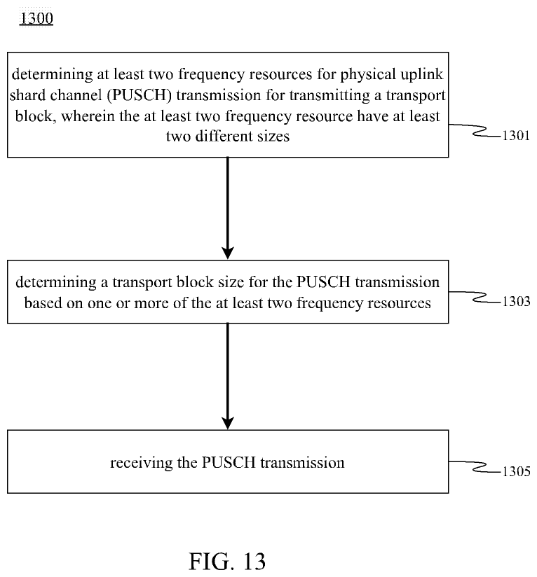

FIG. 13 is a flow chart of a method 1300 performed by a BS according to some embodiments of the present application. The method illustrated in FIG. 13 may be performed by the BS 101 in FIG. 1.

The method 1300 includes operations 1301, 1303, and 1305. In the operation 1301, the BS may determine at least two frequency resources for physical uplink shard channel (PUSCH) transmission for transmitting a transport block. The at least two frequency resource have at least two different sizes. In the operation 1303, the BS may determine a transport block size for the PUSCH transmission based on one or more of the at least two frequency resources. In the operation 1305, the BS may receive the PUSCH transmission. The at least two different sizes may be a number of resource blocks (RBs) or a number of resource elements (REs).

In some embodiments, the PUSCH transmission may be used for repeated transmissions of the transport block on one or multiple slots or may be used for transmitting the transport block over the multiple slots. In the PUSCH repetition Type B scheme, the PUSCH transmission may be used for repeated transmissions of the transport block on one slot.

In some embodiments, the PUSCH transmission for transmitting the transport block may use one of the following schemes: physical uplink share channel (PUSCH) repetition type A, PUSCH repetition type B, or transport block processing over multi-slot (TBOMS).

In some embodiments, the transport block size of the PUSCH transmission may be determined based on one of the at least two frequency resources.

In some embodiments, the transport block size may be determined based on a size of one frequency resource of the at least two frequency resources, and the one frequency resource is used for a first repetition of the PUSCH transmission in time domain or is used for the PUSCH transmission in first slot.

In some embodiments, the first repetition may be a first actual repetition or a first nominal repetition in time domain.

In some embodiments, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments, the transport block size may be determined based on a first frequency resource size of one repetition of the PUSCH transmission indicated by the BS or predetermined in a protocol. The one repetition of the PUSCH transmission may be an actual repetition or a nominal repetition. The PUSCH transmission may use PUSCH repetition type B.

In some embodiments, the transport block size may be determined based on a second frequency resource size of the PUSCH transmission on one slot. The one slot may be indicated by the BS or predetermined in the protocol. The PUSCH transmission may use PUSCH repetition type A or TBOMS.

In some embodiments, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments, the transport block size may be determined based on a smallest size of the at least two frequency resources.

In some embodiments, the transport block size may be determined based on a biggest size of the at least two frequency resources.

In some embodiments, the transport block size may be determined based on a size of one frequency resource of the at least two frequency resources. The one frequency resource may be used for the PUSCH transmission in a time unit without sub-band full-duplex transmission. The time unit may be a slot, a symbol, a frame, a sub-frame, or a sub-slot.

In some embodiments, the transport block size may be determined based on a size of one frequency resource of the at least two frequency resources. The one frequency resource may be used for the PUSCH transmission in a time unit with sub-band full-duplex transmission. The time unit may be a slot, a symbol, a frame, a sub-frame, or a sub-slot.

In some embodiments, the transport block size may be determined based on one size indicated by the BS among the at least two different sizes.

In some embodiments, the transport block size may be determined based on a size of one frequency resource of the at least two frequency resources. The one frequency resource may be used most frequently for the PUSCH transmission.

In some embodiments, the transport block size may be determined based on a scaling factor and one or more of the at least two frequency resources. The scaling factor may be assigned by the BS or predetermined in a protocol.

In some embodiments, the at least two frequency resources may be used for transmitting the transport block over multiple slots. The transport block size may be determined based on all sizes of the at least two different sizes.

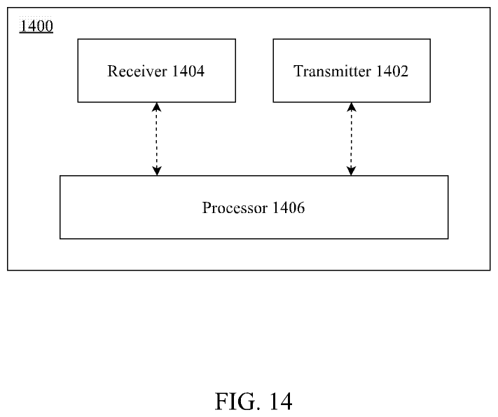

FIG. 14 is a block diagram of an exemplary apparatus 1400 according to some embodiments of the present application. The apparatus 1400 may be a UE (e.g., the UE 103) or a BS (e.g., the BS 101).

Referring to FIG. 14, the apparatus 1400 may include at least one transmitter 1402, at least one receiver 1404, and at least one processor 1406. The at least one transmitter 1402 is coupled to the at least one processor 1406, and the at least one receiver 1404 is coupled to the at least one processor 1406. The at least one transmitter 1402 may be coupled with the at least one receiver 1404.

Although in this figure, elements such as the transmitter 1402, the receiver 1404, and the processor 1406 are illustrated in the singular, the plural is contemplated unless a limitation to the singular is explicitly stated. In some embodiments of the present application, the transmitter 1402 and the receiver 1404 may be combined to one device, such as a transceiver. In some embodiments of the present application, the apparatus 1400 may further include an input device, a memory, and/or other components. The transmitter 1402, the receiver 1404, and the processor 1406 may be configured to perform any of the methods described herein (e.g., the method described with respect to any of FIGS. 12 and 13).

According to some embodiments of the present application, the apparatus 1400 may be a UE. In some embodiments of the present application, the processor 1406 may be configured to determine at least two frequency resources for physical uplink shard channel (PUSCH) transmission for transmitting a transport block, wherein the at least two frequency resources have at least two different sizes; determine a transport block size for the PUSCH transmission based on one or more of the at least two frequency resources; and perform, via a wireless transceiver (or the transmitter 1402, the receiver 1404), the PUSCH transmission. The at least two different sizes may be a number of resource blocks (RBs) or a number of resource elements (REs).

In some embodiments of the present application, the PUSCH transmission may be used for repeated transmissions of the transport block on one or multiple slots or may be used for transmitting the transport block over the multiple slots.

In some embodiments of the present application, the PUSCH transmission for transmitting the transport block may use one of the following schemes: physical uplink share channel (PUSCH) repetition type A, PUSCH repetition type B, or transport block processing over multi-slot (TBOMS).

In some embodiments of the present application, the transport block size of the PUSCH transmission may be determined based on one of the at least two frequency resources.

In some embodiments of the present application, the transport block size may be determined based on a size of one frequency resource of the at least two frequency resources. The one frequency resource may be used for a first repetition of the PUSCH transmission in time domain or is used for the PUSCH transmission in a first slot.

In some embodiments of the present application, the first repetition may be a first actual repetition or a first nominal repetition in time domain.

In some embodiments of the present application, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments of the present application, the transport block size may be determined based on a first frequency resource size of one repetition of the PUSCH transmission indicated by abase station (BS) or predetermined in a protocol. The one repetition of the PUSCH transmission may be an actual repetition or a nominal repetition. The PUSCH transmission may use PUSCH repetition type B.

In some embodiments of the present application, the transport block size may be determined based on a second frequency resource size of the PUSCH transmission on one slot. The one slot may be indicated by a base station (BS) or predetermined in the protocol. The PUSCH transmission may use PUSCH repetition type A or TBOMS.

In some embodiments of the present application, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments of the present application, the transport block size may be determined based on a smallest size of the at least two frequency resources.

In some embodiments of the present application, the transport block size may be determined based on a biggest size of the at least two frequency resources.

In some embodiments of the present application, the transport block size may be determined based on a size of one frequency resource of the at least two frequency resources. The one frequency resource may be used for the PUSCH transmission in a time unit without sub-band full-duplex transmission. The time unit may be a slot, a symbol, a frame, a sub-frame, or a sub-slot.

In some embodiments of the present application, the transport block size may be determined based on a size of one frequency resource of the at least two frequency resources. The one frequency resource is used for the PUSCH transmission in a time unit with sub-band full-duplex transmission. The time unit may be a slot, a symbol, a frame, a sub-frame, or a sub-slot.

In some embodiments of the present application, the transport block size may be determined based on one size indicated by a base station (BS) among the at least two different sizes.

In some embodiments of the present application, the transport block size may be determined based on a size of one frequency resource of the at least two frequency resources. The one frequency resource may be used most frequently for the PUSCH transmission.

In some embodiments of the present application, the transport block size may be determined based on a scaling factor and one or more of the at least two frequency resources. The scaling factor may be assigned by a BS or predetermined in a protocol.

In some embodiments of the present application, the at least two frequency resources may be used for transmitting the transport block over multiple slots. The transport block size is determined based on all sizes of the at least two different sizes.

According to some embodiments of the present application, the apparatus 1400 may be a BS. In some embodiments of the present application, the processor 1406 may be configured to determine at least two frequency resources for physical uplink shard channel (PUSCH) transmission for transmitting a transport block, wherein the at least two frequency resource have at least two different sizes; determine a transport block size for the PUSCH transmission based on one or more of the at least two frequency resources; and receive, via a wireless transceiver (or the transmitter 1402, the receiver 1404), the PUSCH transmission. The at least two different sizes may be a number of resource blocks (RBs) or a number of resource elements (REs).

In some embodiments of the present application, the PUSCH transmission may be used for repeated transmissions of the transport block on one or multiple slots or may be used for transmitting the transport block over the multiple slots.

In some embodiments of the present application, the PUSCH transmission for transmitting the transport block may use one of the following schemes: physical uplink share channel (PUSCH) repetition type A, PUSCH repetition type B, or transport block processing over multi-slot (TBOMS).

In some embodiments of the present application, the transport block size of the PUSCH transmission may be determined based on one of the at least two frequency resources.

In some embodiments of the present application, the transport block size may be determined based on a size of one frequency resource of the at least two frequency resources. The one frequency resource may be used for a first repetition of the PUSCH transmission in time domain or is used for the PUSCH transmission in first slot.

In some embodiments of the present application, the first repetition may be a first actual repetition or a first nominal repetition in time domain.

In some embodiments of the present application, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments of the present application, the transport block size may be determined based on a first frequency resource size of one repetition of the PUSCH transmission indicated by the BS or predetermined in a protocol. The one repetition of the PUSCH transmission may be an actual repetition or a nominal repetition. The PUSCH transmission may use PUSCH repetition type B.

In some embodiments of the present application, the transport block size may be determined based on a second frequency resource size of the PUSCH transmission on one slot. The one slot may be indicated by the BS or predetermined in the protocol. The PUSCH transmission may use PUSCH repetition type A or TBOMS.

In some embodiments of the present application, the PUSCH transmission may be a remaining PUSCH transmission after handling the collision between PUSCH transmission and semi-static DL symbol configured by tdd-UL-DL-ConfigurationCommon or tdd-UL-DL-ConfigurationDedicated.

In some embodiments of the present application, the transport block size may be determined based on a smallest size of the at least two frequency resources.

In some embodiments of the present application, the transport block size may be determined based on a biggest size of the at least two frequency resources.

In some embodiments of the present application, the transport block size may be determined based on a size of one frequency resource of the at least two frequency resources. The one frequency resource may be used for the PUSCH transmission in a time unit without sub-band full-duplex transmission. The time unit may be a slot, a symbol, a frame, a sub-frame, or a sub-slot.

In some embodiments of the present application, the transport block size may be determined based on a size of one frequency resource of the at least two frequency resources, and the one frequency resource is used for the PUSCH transmission in a time unit with sub-band full-duplex transmission. The time unit may be a slot, a symbol, a frame, a sub-frame, or a sub-slot.

In some embodiments of the present application, the transport block size may be determined based on one size indicated by the BS among the at least two different sizes.

In some embodiments of the present application, the transport block size may be determined based on a size of one frequency resource of the at least two frequency resources. The one frequency resource may be used most frequently for the PUSCH transmission.

In some embodiments of the present application, the transport block size may be determined based on a scaling factor and one or more of the at least two frequency resources. The scaling factor may be assigned by the BS or predetermined in a protocol.

In some embodiments of the present application, the at least two frequency resources may be used for transmitting the transport block over multiple slots. The transport block size may be determined based on all sizes of the at least two different sizes.

In some embodiments of the present application, the apparatus 1400 may further include at least one non-transitory computer-readable medium. In some embodiments of the present disclosure, the non-transitory computer-readable medium may have stored thereon computer-executable instructions to cause the processor 1406 to implement any of the methods as described above. For example, the computer-executable instructions, when executed, may cause the processor 1406 to interact with the transmitter 1402 and/or the receiver 1404, so as to perform operations of the methods, e.g., as described with respect to FIGS. 12 and 13.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for determining TBS, including a processor and a memory. Computer programmable instructions for implementing a method for determining TBS are stored in the memory, and the processor is configured to perform the computer programmable instructions to implement the method for determining TBS. The method for determining TBS may be any method as described in the present application.

Persons skilled in the art should understand that as the technology develops and advances, the terminologies described in the present application may change, and should not affect or limit the principle and spirit of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for determining a transport block size according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
determine at least two frequency resources for physical uplink shared channel (PUSCH) transmission for transmitting a transport block, wherein the at least two frequency resources have at least two different sizes;
determine a transport block size for the PUSCH transmission based on one or more of the at least two frequency resources; and
perform the PUSCH transmission.

2. The UE of claim 1, wherein the PUSCH transmission are used for repeated transmissions of the transport block on one or multiple slots or are used for transmitting the transport block over the multiple slots.

3. The UE of claim 1, wherein the transport block size of the PUSCH transmission is determined based on one of the at least two frequency resources.

4. The UE of claim 3, wherein the transport block size is determined based on a size of one frequency resource of the at least two frequency resources, and the one frequency resource is used for a first repetition of the PUSCH transmission in time domain or is used for the PUSCH transmission in a first slot.

5. The UE of claim 4, wherein the first repetition is a first actual repetition or a first nominal repetition in time domain.

6. The UE of claim 3, wherein the transport block size is determined based on a first frequency resource size of one repetition of the PUSCH transmission indicated by a base station or predetermined in a protocol.

7. The UE of claim 3, wherein the transport block size is determined based on a second frequency resource size of the PUSCH transmission on one slot, the one slot is indicated by a base station or predetermined in a protocol.

8. The UE of claim 3, wherein the transport block size is determined based on a smallest size of the at least two frequency resources.

9. The UE of claim 3, wherein the transport block size is determined based on a size of one frequency resource of the at least two frequency resources, and the one frequency resource is used for the PUSCH transmission in a time unit with sub-band full-duplex transmission.

10. The UE of claim 3, wherein the transport block size is determined based on one size indicated by a base station among the at least two different sizes.

11. The UE of claim 3, wherein the transport block size is determined based on a size of one frequency resource of the at least two frequency resources, and the one frequency resource is used most frequently for the PUSCH transmission.

12. The UE of claim 3, wherein the transport block size is determined based on a scaling factor and one or more of the at least two frequency resources, and the scaling factor is assigned by a base station or predetermined in a protocol.

13. The UE of claim 1, wherein the at least two frequency resources are used for transmitting the transport block over multiple slots, and the transport block size is determined based on all sizes of the at least two different sizes.

14. A base station, comprising:
at least one memory; and
at least one processor coupled with the at least one memory and configured to cause the base station to:
determine at least two frequency resources for physical uplink shared channel (PUSCH) transmission for transmitting a transport block, wherein the at least two frequency resource have at least two different sizes;
determine a transport block size for the PUSCH transmission based on one or more of the at least two frequency resources; and
receive the PUSCH transmission.

15. The base station of claim 14, wherein the at least two frequency resources are used for transmitting the transport block over multiple slots, and the transport block size is determined based on all sizes of the at least two different sizes.

16. The UE of claim 1, wherein at least two frequency domain resources comprise at least two numbers of resource blocks (RBs).

17. The UE of claim 1, wherein a first frequency domain resource is indicated, and a second frequency domain resource is determined by reducing the first frequency domain resource to fit a size of a sub-band.

18. A processor for wireless communication, comprising:
at least one controller coupled with at least one memory and configured to cause the processor to:
determine at least two frequency resources for physical uplink shared channel (PUSCH) transmission for transmitting a transport block, wherein the at least two frequency resources have at least two different sizes;
determine a transport block size for the PUSCH transmission based on one or more of the at least two frequency resources; and
perform the PUSCH transmission.

19. The processor of claim 18, wherein the PUSCH transmission are used for repeated transmissions of the transport block on one or multiple slots or are used for transmitting the transport block over the multiple slots.

20. A method performed by a user equipment (UE), the method comprising:
determining at least two frequency resources for physical uplink shared channel (PUSCH) transmission for transmitting a transport block, wherein the at least two frequency resources have at least two different sizes;
determining a transport block size for the PUSCH transmission based on one or more of the at least two frequency resources; and
performing the PUSCH transmission.
